(19) United States
(12) Patent Application Publication
(10) Pub. No.: US 2010/0332690 A1
(43) Pub. Date: Dec. 30, 2010

(54) PROCESSOR PERFORMANCE ANALYSIS DEVICE, METHOD, AND SIMULATOR

(75) Inventors: Osamu Kawamura, Osaka (JP); Atsushi Ubukata, Kyoto (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/864,935

(22) PCT Filed: Jan. 23, 2009
(86) PCT No.: PCT/JP2009/000246

§ 371 Date: Jul. 28, 2010

(30) Foreign Application Priority Data
Jan. 29, 2008 (JP) 2008-017714

(51) Int. Cl. G06F 3/00; G06F 12/10

(52) U.S. Cl. 710/15; 711/207; 711/E12.061

(57) ABSTRACT

A processor performance analysis device analyzes performance of a multithreaded processor in a system LSI which includes: the multithreaded processor which executes processing in parallel using multiple logical processors; a functional core which executes processing different from the processing executed by the multithreaded processor; and a memory interface which receives each access request and controls access to memory. The processor performance analysis device includes: an operational information output unit which monitors the multithreaded processor to output operational information; an access information output unit which monitors the memory interface to output memory access information; and an analysis information output unit which analyzes the performance of the multithreaded processor using the operational information and the memory access information.

### TECHNICAL FIELD

The present invention relates to a device which analyzes processor performance in a system large scale integration (LSI), and in particular, to a device which analyzes performance of a multithreaded processor which includes multiple logical processors inside the processor and is capable of executing multiple programs simultaneously and in parallel.

### BACKGROUND ART

Along with miniaturization in fabrication process techniques of semiconductors, integrating more functions on a single chip can improve cost effectiveness and functions. The system LSI on which processors and functional cores other than the processors are integrated is widely used today for digital TVs, digital recorders and the like. Examples of the functional cores include a general-purpose interface (IF) circuit such as a peripheral component interconnect (PCI) bus and an integrated drive electronics (IDE) bus, a codec circuit which encodes and decodes content data such as video and music, and an encryption circuit for protecting copyright information such as paid content.

Since the system LSI includes various kinds of integrated functions, there is a strong demand for parallel processing of software programs which control functional processing. Therefore, a multithreaded processor suited for parallel execution of multiple programs is often used for improving processing performance of the system LSI.

On the other hand, in order to efficiently perform parallel execution of multiple programs in the multithreaded processor, consideration is required for avoiding performance bottleneck caused due to excessive access when using a common resource such as memory. However, it is not easy to understand behavior of multithreading in which multiple factors are intertwined in complex ways. In such a system where many environmental factors are intertwined in complex ways, it is extremely difficult to determine if the inappropriate part is the control of switching of processing between threads in hardware of the multithreaded processor or is the algorithms of software which are executed simultaneously and in parallel. More specifically, it is difficult to allow capability of the system LSI to run effectively.

In order to solve the problems, it is required to provide a processor performance evaluation device which understands processing performance of a processor when multithread processing is executed.

As a conventional processor performance evaluation device, there is a device which outputs conditions of buffers, queues, and selectors for memory access in a processor, and hits and misses in a cache, a branch estimation and translation lookaside buffer (TLB) in association with each other on the same time axis (for example, see Patent Reference 1). FIG. 8 is a block diagram showing a conventional processor performance evaluation device disclosed in Patent Reference 1.

A computer 30 shown in FIG. 8 includes an instruction unit 401, an arithmetic unit 402, a primary cache unit 403, and a secondary cache unit 404.

The secondary cache unit 404 includes a secondary cache 405 and an external access unit 406, and outputs respective hardware information in the computer. The secondary cache 405 outputs information such as the number of accesses, the number of hits, and request categories. The external access unit 406 outputs information such as the number of write and read queues implemented in an access buffer for access between the secondary cache 405 and a memory 40.

Further, in order to associate the operations of the instruction unit 401 and the arithmetic unit 402 with the operations of the secondary cache 405 and the external access unit 406, the conventional processor performance evaluation device sets a core ID or the like for identifying the instruction unit 401 and the arithmetic unit 402, and outputs information indicating the part that is using the secondary cache 405 and the external access unit 406. Those output information allow determination of the operations of the entire computer, which facilitates analysis of performance bottlenecks.

### DISCLOSURE OF INVENTION

### Problems that Invention is to Solve

The conventional configuration allows determination of causes of performance degradation, such as cache misses and TLB misses which occur within the processor; however, the conventional configuration does not provide information concerning causes of performance degradation which occur due to other than the processor. Examples of causes of performance degradation which occur due to other than the processor include an event in which memory access latency from the processor is high because direct memory access (DMA) transfer of a functional core occupies memory interface resource.

The present invention has been conceived in view of the above problems, and has an object to provide a processor performance analysis device which can analyze causes of system performance degradation including not only the operating state within the processor, but also the operating state of functional cores other than the processor.

### Means to Solve the Problems

In order to solve the problems, the processor performance analysis device according to an aspect of the present invention analyzes performance of a processor in a system LSI including: the processor which includes a plurality of logical processors, executes processing in parallel using the logical processors, and issues a first access request to access a memory; a functional core which executes processing different from the processing executed by the processor and issues a second access request to access the memory; and a memory interface which receives the first access request and the second access request and controls access to the memory. The processor performance analysis device includes: a first information output unit which monitors the processor to output first information indicating an operating state of the processor; a second information output unit which monitors the memory interface to output second information indicating a state of a memory access caused by the first and the second access requests received by the memory interface; and an analysis unit which analyzes the performance of the processor using the first information and the second information.

With this, it is possible to analyze causes of performance degradation which occur due to memory access not only from the multithreaded processor but also from the functional cores.

Furthermore, it may be that the processor performance analysis device further includes a third information output unit which monitors the processor to output third information indicating a cause of the issuance of the first access request by the processor, in which the analysis unit further analyzes the performance of the processor using the third information.

For example, it may be that the processor issues the first access request to access the memory for each of the logical processors, and the third information output unit outputs, as the third information, attribute information identifying a logical processor which is included in the logical processors and which issued the first access request.

Further, it may be that the processor issues the first access request when a prefetch or a cache miss occurs, and the third information output unit outputs, as the third information, information indicating which one of the prefetch or the cache miss is the cause of the issuance of the first access request by the processor.

More specifically, the cache miss is one of an instruction cache miss, a data cache miss, and a translation lookaside buffer (TLB) miss.

With this, more specific information concerning a source of an access request issued by a processor can be obtained, which allows more detailed analysis of the processor performance.

Further, it may be that the second information output unit outputs, as the second information, information indicating which one of the first access request and the second access request was received by the memory interface.

Further, it may be that the second information output unit outputs, as the second information, either (i) information concerning waiting order of the first access request or the second access request, or (ii) information concerning time period from when the first access request or the second access request is received till a data transfer is completed.

With this, more specific information concerning processing status of memory access request can be obtained, which allows more detailed analysis of the processor performance.

Further, it may be that the first information output unit outputs, as the first information, information indicating one of (i) whether each of the logical processors is operating or is in a waiting state, (ii) a cache hit or a cache miss of the processor, and (iii) a hit or a miss of a prefetch operation.

With this, more specific information concerning operating state of the processor can be obtained, which allows more detailed analysis of the processor performance.

Further, it may be that the system LSI includes a plurality of processors including the processor, and the processor performance analysis device includes first information output units each corresponding to the respective processors, the first information output units including the first information output unit.

With this, it is possible to obtain information such as operating states and memory access status of respective processors, which allows analysis of performance of a system including multiple processors.

Further, it may be that the processor performance analysis device further includes a trigger output unit which outputs a trigger signal when the trigger output unit receives an analysis result of the processor made by the analysis unit and the analysis result meets a predetermined condition.

With this, various processing can be executed depending on the state of the processor by outputting a trigger signal for controlling external devices based on the analysis result of the processor performance. For example, it is possible to verify software operation when a system bottleneck occurs.

Further, it may be that the processor performance analysis device further includes a bus access attribute information output unit which monitors the processor to output fourth information concerning the third access request issued for the functional core by the processor via a bus connecting the processor and the functional core, in which the analysis unit further analyzes the performance of the processor using the fourth information.

With this, it is possible to obtain information concerning operating state of a processor which is derived from access from a processor to a functional core, which allows more detailed analysis of the processor performance.

Further, the present invention can also be implemented as a processor performance analysis simulator for analyzing performance of a processor in a system LSI, in which the system LSI includes: the processor which includes a plurality of logical processors, executes processing in parallel using the logical processors, and issues a first access request to access a memory; a functional core which executes processing different from the processing executed by the processor and issues a second access request to access the memory; and a memory interface which receives the first access request and the second access request and controls access to the memory. The processor performance analysis simulator includes: a first information output unit which monitors the processor to output first information indicating an operating state of the processor; a second information output unit which monitors the memory interface to output second information indicating a state of a memory access caused by the first and the second access requests received by the memory interface; and an analysis unit which analyzes the performance of the processor using the first information and the second information.

Further, the present invention can be implemented not only as a device, but also as: a method which includes processing units that are included in the device as steps; a program which causes a computer to execute those steps; a recording medium such as a computer-readable CD-ROM which stores the program; information, data, and signals which indicate the program. Such program, information, data and signals may be distributed over a communication network such as the Internet.

### Effects of the Invention

A processor performance analysis device according to an aspect of the present invention can evaluate processor performance taking into consideration with influences of memory access operations of functional cores other than processors included in a system LSI. Further, analysis of performance bottleneck can be easily performed, which facilitates performance improvement with modification of software and hardware.

### BRIEF DESCRIPTION OF DRAWINGS

FIG. 1 is a block diagram of a system LSI which includes a processor performance analysis device according to Embodiment 1.

FIG. 2 is a flowchart showing operations of the processor performance analysis device according to Embodiment 1.

FIG. 3 is a block diagram of a system LSI which includes a processor performance analysis device according to Embodiment 2.

FIG. 4 is a flowchart showing operations of the processor performance analysis device according to Embodiment 2.

FIG. 5 is a block diagram of a system LSI which includes a processor performance analysis device according to Embodiment 3.

FIG. 6 is a flowchart showing operations of the processor performance analysis device according to Embodiment 3.

FIG. 7 is a block diagram of a system LSI which includes multiple multithreaded processors.

FIG. 8 is a block diagram of a conventional processor performance analysis device.

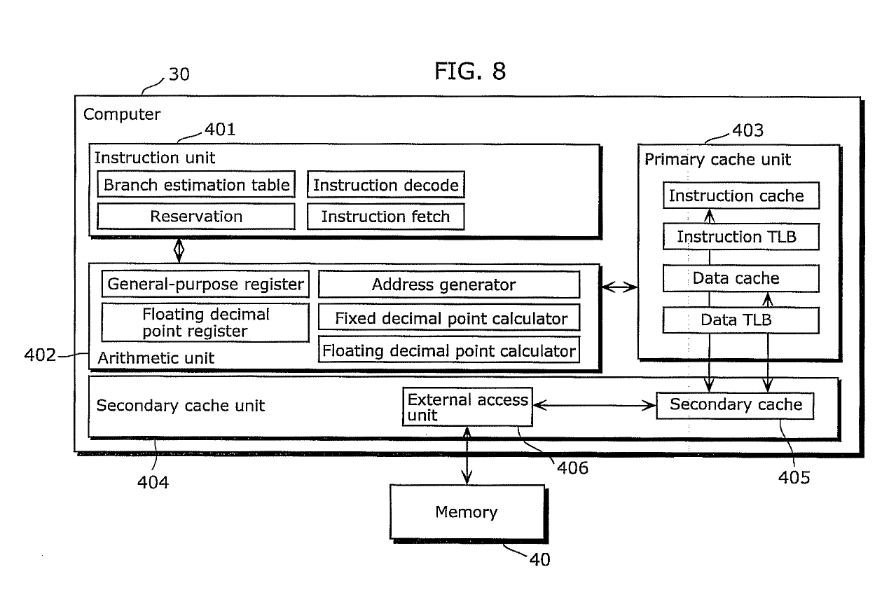

### NUMERICAL REFERENCES

10 System LSI
11 Multithreaded processor
12 Functional core
13 Memory interface
20, 40 Memory
30 Computer
100, 200, 300 Processor performance analysis device
101 Operational information output unit
102 Access attribute information output unit
103 Access information output unit
104, 204, 304 Analysis information output unit
201 Trigger output unit
301 IO bus access attribute information output unit
401 Instruction unit
402 Arithmetic unit
403 Primary cache unit
404 Secondary cache unit
405 Secondary cache
406 External access unit

### BEST MODE FOR CARRYING OUT THE INVENTION

Hereinafter, embodiments of the present invention are described with reference to the drawings.

### Embodiment 1

First, a configuration of a system LSI which includes a processor performance analysis device according to the present embodiment is described.

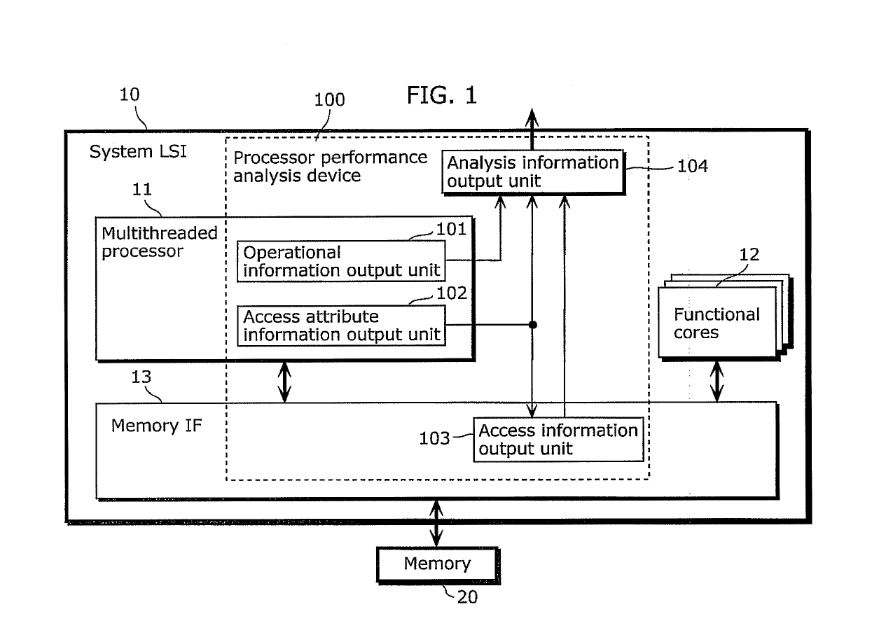

FIG. 1 is a block diagram of a system LSI which includes a processor performance analysis device according to the present embodiment. A system LSI 10 includes a multithreaded processor 11, functional cores 12, and a memory interface 13.

The multithreaded processor 11 includes multiple logical processors (LPs), and can execute multiple programs simultaneously and in parallel using the logical processors. Further, when executing the programs, where necessary, the multithreaded processor 11 issues a memory access request to access to a memory 20 to write or read instructions or data to or from the memory 20. The multithreaded processor 11 includes a primary cache, a secondary cache, a TLB (not shown) and the like. The multithreaded processor 11 issues a memory access request to access to the memory 20, for example, when a prefetch or a cache miss occurs. The memory access request is issued by each logical processor.

The functional cores 12 are multiple functional cores which execute processing different from that of the multithreaded processor 11, and issue memory access requests to access to the memory 20. Examples of the functional cores 12 include a DMA controller, an interface circuit to an external device, audio visual (AV) codec circuit which compresses or expands content data of music and video, and an encryption and decryption circuit which encrypts and decrypts data. Examples of the interface circuit to an external device include a PCI interface and a universal serial bus (USB) interface. A

DMA controller which is one of the functional cores 12 controls access between each functional core 12 and the memory 20. It is to be noted that the number of the functional cores 12 does not always have to be multiple.

The memory interface 13 receives the memory access requests to access to the memory 20 that are issued by the multithreaded processor 11 and the functional cores 12. The memory interface 13 adjusts the received memory access requests to control access to the memory 20.

Next, configuration of the processor performance analysis device according to the present embodiment is described.

The processor performance analysis device according to the present embodiment analyses the operating state of the multithreaded processor 11 included in the system LSI 10 and the status of the memory access from the multithreaded processor 11 and the functional cores 12.

FIG. 1 also shows the configuration of the processor performance analysis device according to the present embodiment. A processor performance analysis device 100 in FIG. 1 includes an operational information output unit 101, an access attribute information output unit 102, an access information output unit 103, and an analysis information output unit 104. As shown in FIG. 1, the operational information output unit 101 and the access attribute information output unit 102 are included in the multithreaded processor 11. Further, the access information output unit 103 is included in the memory interface 13.

The operational information output unit 101 monitors the multithreaded processor 11 to dynamically output operational information which indicates internal operating state of the multithreaded processor 11. Examples of the operational information include information concerning whether respective logical processors are operating or are waiting for data access, whether or not the number of the operating logical processors is greater than the number of the arithmetic units, that is whether or not a wait state is occurring, whether or not the logical processors are executing prefetch accesses, whether a prefetch hit or miss is occurring, whether instruction cache and data cache hits or misses are occurring, whether TLB hit or miss is occurring, or whether secondary cache hit or miss is occurring.

The access attribute information output unit 102 monitors the multithreaded processor 11 to output memory access attribute information concerning a memory access request to access the memory 20 issued by the multithreaded processor 11. The memory access attribute information is, for example, an ID information which indicates which logical processor is issuing the memory access request. Further examples of the memory access attribute information include access cause information indicating that the issuance of the memory access request was caused by an instruction or data prefetch, by an instruction or data cache miss, by a TLB miss, by a secondary cache miss, by an access to uncacheable region or the like.

The access information output unit 103 monitors the memory interface 13 to output memory access information concerning status of the memory access caused by the memory access request received by the memory interface 13. The memory access information is, for example, information which indicates whether the received memory access request was issued by the multithreaded processor 11 or the functional core 12.

Here, the access information output unit 103 outputs, as memory access information, the memory access attribute information output by the access attribute information output unit 102 and the internal operating state of the memory interface 13 in association with each other when the received memory access request was issued by the multithreaded processor 11. Examples of the information output as the memory access information is information indicating which logical processor having which ID information issued the received memory access request or the received memory access request was issued due to prefetch, cache miss, or TLB miss. Other examples of the memory access information include information of time period from when the access request is received till data transfer starts and/or ends, and information of the number of received access requests and the order of processing queues when several access requests are simultaneously received.

The analysis information output unit 104 outputs analysis information concerning system performance in association with the operational information, the memory access attribute information and the memory access information. Examples of the analysis information include information on: time period during which all the logical processors of the multithreaded processor 11 are not operating and are in wait state; cache hit rate, the number of memory accesses, and memory access latency of each logical processor; and increased latency period for memory access of the multithreaded processor 11 caused by memory access of the functional core 12.

Next, the operations of the processor performance analysis device 100 according to the present embodiment are described.

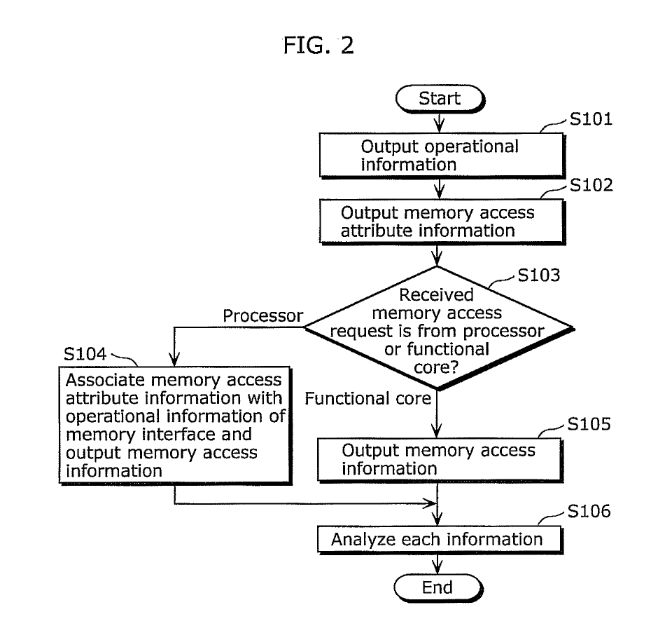

FIG. 2 is a flowchart the showing operations of the processor performance analysis device 100 according to present embodiment.

The operational information output unit 101 monitors the logical processors included in the multithreaded processor 11 to output operational information indicating the processing state of the respective logical processors (S101). To be more specific, the operational information output unit 101 outputs, as operational information, information indicating whether the respective logical processors are operating or waiting for data access, and information indicating, for example, whether cache hit or miss is occurring.

The access attribute information output unit 102 monitors the logical processors to output memory access attribute information concerning a memory access request to access the memory 20 issued by the multithreaded processor 11 (S102). To be more specific, the access attribute information output unit 102 outputs memory access attribute information indicating, for example, ID information for identifying the logical processor which issued the memory access request, and access cause information which indicates a cause of the issuance of the memory access request.

Next, the access information output unit 103 monitors the memory interface 13 to determine whether or not the memory access request received by the memory interface 13 was issued by the multithreaded processor 11 or the functional core 12 (S103).

When the memory access request was issued by the multithreaded processor 11 (“processor” in S103), the access information output unit 103 associates the memory access attribute information output by the access attribute information output unit 102 with the operating state of the memory interface 13 and outputs memory access information (S104). More specifically, the access information output unit 103 outputs memory access information, such as information for identifying the logical processor which issued the received memory access request and information and indicating whether the memory access request was issued due to prefetch or cache miss.

When the received memory access request was issued by the functional core 12 (“functional core” in S103), the access information output unit 103 outputs, as memory access information, information indicating, for example, that the received memory access request was issued by the functional core 12 (S105).

Lastly, the analysis information output unit 104 outputs analysis information by analyzing the operating state of the system LSI 10 using the operational information (output in S101), the memory access attribute information (output in S102), and the memory access information (output in S104 or S105).

It is to be noted that one of the operational information (S101) and the memory access attribute information (S102) may be output first, or both of them may be output in parallel.

As described above, the processor performance analysis device according to the present embodiment can understand the operating state of the entire system by associating the operational information of the processor with the memory access information from the processor and the functional cores. The above configuration allows appropriate analysis of system bottleneck and consideration of system performance improvement.

### Embodiment 2

A processor performance analysis device according to the present embodiment outputs a trigger signal for controlling external devices and the like, based on an analysis result of processor performance.

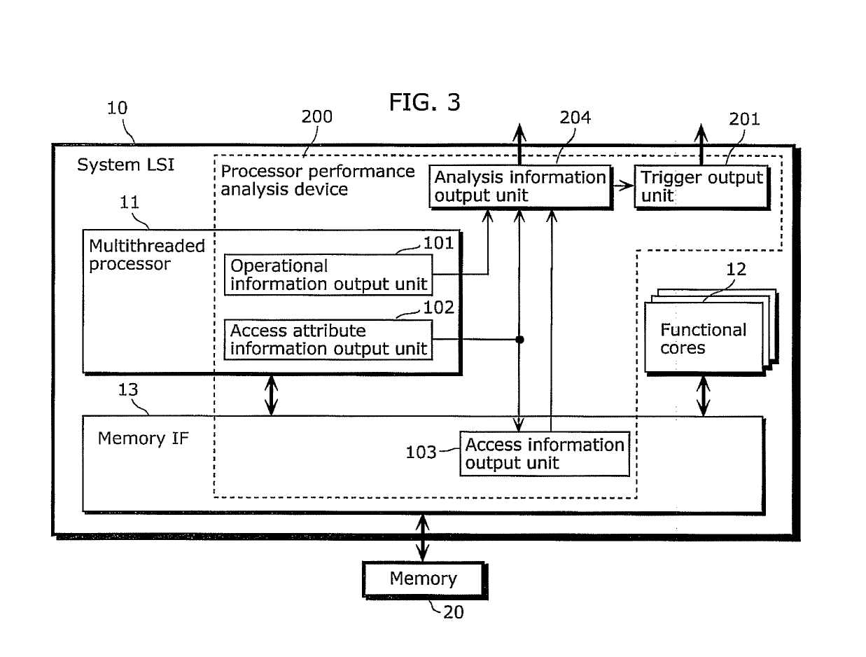

FIG. 3 is a block diagram of a system LSI which includes the processor performance analysis device according to the present embodiment. A processor performance analysis device 200 shown in FIG. 3 is different from the processor performance analysis device 100 shown in FIG. 1 in that a trigger output unit 201 is added and that an analysis information output unit 204 is included instead of the analysis information output unit 104. Hereinafter, descriptions of elements identical to those of FIG. 1 are not repeated, and only differences are mainly described.

When the trigger output unit 201 receives, from the analysis information output unit 204, a signal indicating that the system state meets certain conditions, the trigger output unit 201 outputs a trigger signal outside the system LSI 10. For example, the trigger output unit 201 outputs a trigger signal to a debugger which is connected outside the system LSI 10 and which is for the multithreaded processor 11. Further, examples of the system state detected by the analysis information output unit 204 include a state of a bottleneck in a system such as a state where all the logical processors of the multithreaded processor 11 are waiting for data, stopping execution of all the programs, and where memory access latency of a certain logical processor exceeds a predetermined value.

The analysis information output unit 204 generates analysis information in association with the operational information, the memory access attribute information, and the memory access information, and outputs the generated analysis information not only to outside the system LSI 10 but also to the trigger output unit 201. Specific examples of the analysis information are the same as those described in Embodiment 1.

Next, the operations of the processor performance analysis device 200 according to the present embodiment are described.

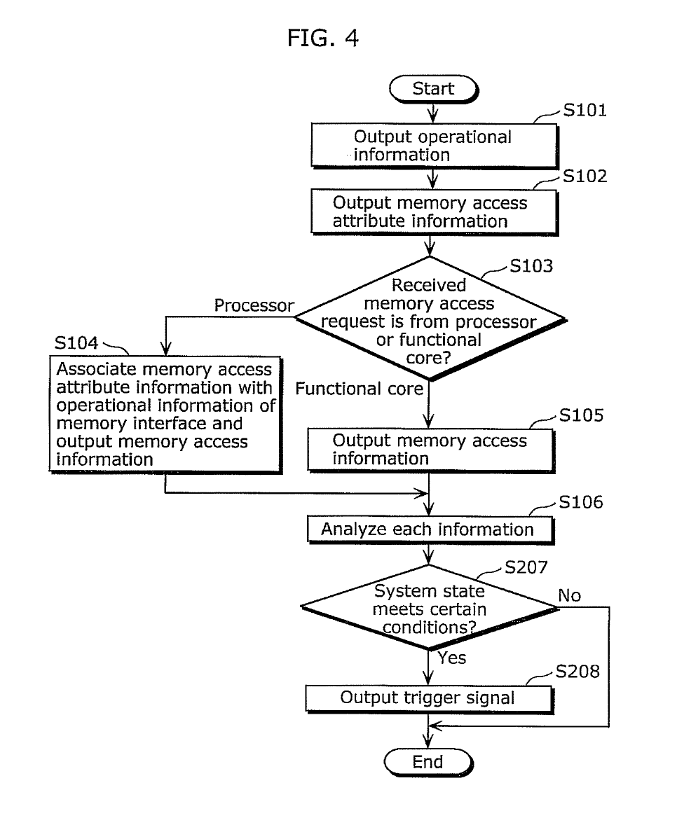

FIG. 4 is a flowchart showing operations of the processor performance analysis device 200 according to the present embodiment. The processing shown in FIG. 4 is different from the processing shown in FIG. 2 in that processing for outputting a trigger signal (S207 and S208) is added. In FIG. 4, the processing assigned with the referential numbers same as those in FIG. 2 are the same processing as those in Embodiment 1, and descriptions of them are not repeated.

As described in Embodiment 1, the analysis information output unit 204 analyzes the operating state of the system LSI 10 using the operational information (output in S101), the memory access attribute information (output in S102), and the memory access information (output in S104 or S105) to output analysis information (S106).

The trigger output unit 201 determines whether or not the system state indicated by the analysis information output by the analysis information output unit 204 meets the certain conditions (S207). When the system state meets the certain conditions (Yes in S207), the trigger output unit 201 outputs, to outside the system LSI 10, a trigger signal indicating that the system state meets the certain conditions (S208).

When the system state does not meet the certain conditions (No in S207), the trigger signal is not output, but only analysis information is output outside.

As described, the processor performance analysis device according to the present embodiment outputs a trigger signal for controlling external devices and the like based on an analysis result of the processor performance. This facilitates verification of software operation at the time of occurrence of a system bottleneck, which results in further improving convenience in an analysis of a system bottleneck.

### Embodiment 3

A processor performance analysis device according to the present embodiment can analyze processor performance based on information concerning an access request issued by a processor to a functional core when the processor and the functional core are connected to each other via an IO bus.

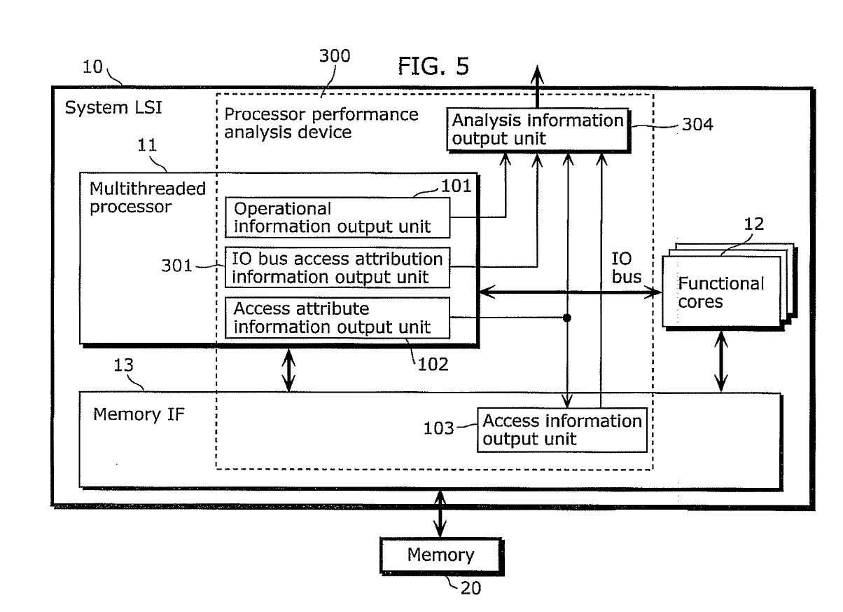

FIG. 5 is a block diagram of a system LSI which includes the processor performance analysis device according to the present embodiment. A processor performance analysis device 300 shown in FIG. 5 is different from the processor performance analysis device 100 shown in FIG. 1 in that an IO bus access attribute information output unit 301 is added and that an analysis information output unit 304 is included instead of the analysis information output unit 104. Hereinafter, descriptions of elements identical to those of FIG. 1 are not repeated, and only differences are mainly described.

The IO bus access attribute information output unit 301 monitors the multithreaded processor 11 to output IO bus access attribute information concerning access requests transferred via IO bus which connects the multithreaded processor 11 and the functional cores 12. For example, the IO bus access attribute information is attribute information concerning an access to a functional core 12 via an IO bus used for, for example, register access from the multithreaded processor 11 to the functional cores 12. Further, the IO bus access attribute information is, for example, an ID information indicating which logical processor is issuing the IO bus access request.

The analysis information output unit 304 generates analysis information in association with the operational information, the memory access attribute information, the memory access information, and the IO bus access attribute information, and outputs the generated analysis information to outside the system LSI 10.

Next, the operations of the processor performance analysis device 300 according to the present embodiment are described.

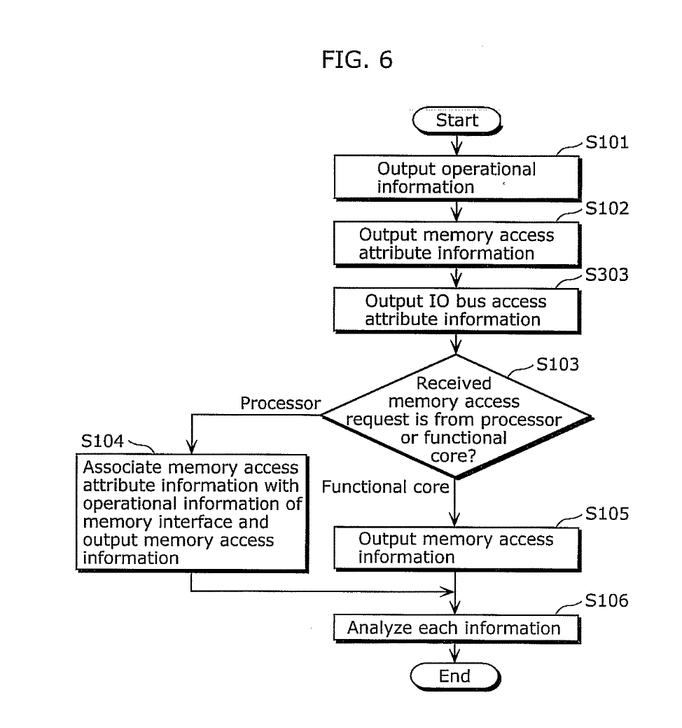

FIG. 6 is a flowchart showing operations of the processor performance analysis device 300 according to present embodiment. The processing shown in FIG. 6 is different from the processing shown in FIG. 2 in that processing for outputting IO bus access attribute information (S303) is further added. In FIG. 6, the processing assigned with the referential numbers same as those in FIG. 2 are the same processing as those in Embodiment 1, and descriptions of them are not repeated.

After outputting the operational information (S101) and the memory access attribute information (S102), the IO bus access attribute information output unit 301 monitors the multithreaded processor 11 to output IO bus access attribute information (S302). When no access request is transferred via the IO bus, it may be that the IO bus access attribute information output unit 301 outputs, as the IO bus access attribute information, information indicating that no access request is being transferred via the IO bus, or does not output the IO bus access attribute information.

Hereinafter, similar to Embodiment 1, the access information output unit 103 outputs the memory access attribute information (S104 or S105). Then, the analysis information output unit 304 analyzes the operating state of the system LSI 10 using the operational information (output in S101), the memory access attribute information (output in S102), the IO bus access attribute information (output in S303), and the memory access information (output in S104 or S105) to output analysis information (S106).

It may be that one of the operational information (S101), the memory access attribute information (S102), and the IO bus access attribute information (S303) is output first, or all of them are output in parallel.

As described, the processor performance analysis device according to the present embodiment can analyze performance penalty caused not only due to access from a processor to memory, but also due to IO bus access from a processor to a functional core. This further improves accuracy in analysis on system bottleneck.

Embodiments of the processor performance analysis device and the processor performance analysis method according to the present invention have been described; however, the present invention is not limited to those embodiments. Those skilled in the art will readily appreciate that many modifications in the exemplary embodiments and combinations of elements in different embodiments are possible without materially departing from the novel teachings and advantages of this invention. Accordingly, all such modifications are intended to be included within the scope of this invention.

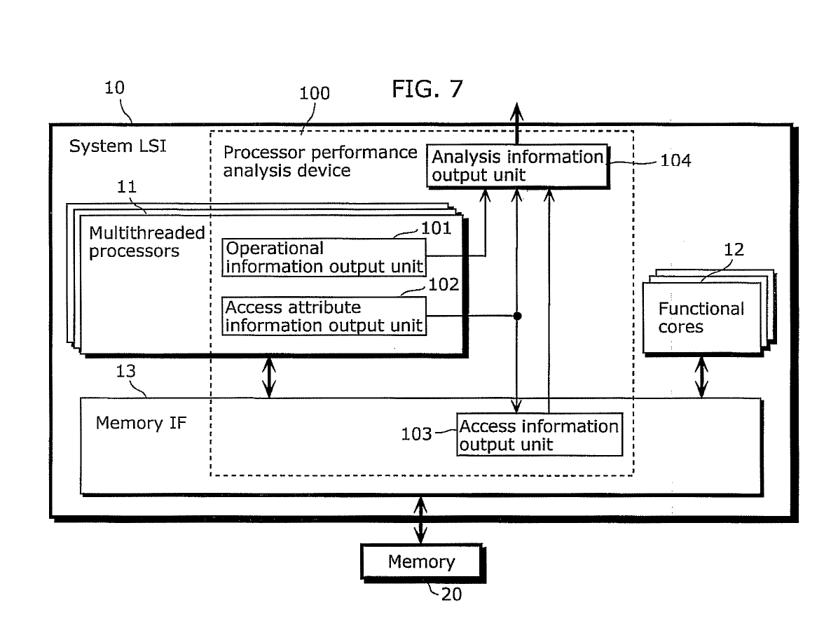

For example, the multithreaded processor 11 is provided as a processor of the system LSI 10 in the embodiments of the present invention; however, a multi-processor configuration which includes multiple processors may be used. For example, as shown in FIG. 7, the system LSI 10 includes multiple multithreaded processors 11. Each of the multithreaded processors 11 includes an operational information output unit 101 and an access attribute information output unit 102.

With this, it is possible to obtain information such as operating states and access status to a memory of respective processors. As a result, it is possible to analyze performance of the system including multiple processors.

Further, analysis processing of performance of a processor included in the system LSI 10 may be simulated by simulating operations of the system LSI 10 according to the embodiments of the present invention. For example, the multithreaded processors 11, the functional cores 12, and the memory interface 13 are implemented on a computer as software. Then, the computer executes the processor performance analysis methods shown in FIGS. 2, 4, and 6. The system performance is analyzed by causing the multithreaded processors 11 and the functional cores 12 implemented on a computer to pseudo-execute predetermined programs or the like.

With this, users can understand system performance before actually configuring a system with hardware, which allows more optimal system configuration.

### INDUSTRIAL APPLICABILITY

The processor performance analysis device according to an aspect of the present invention is useful for analyzing performance bottlenecks in system LSI and for considering performance improvement with modification of hardware and software. For example, the present invention can be applied to debug parallel programming of multithreaded processor.

1. A processor performance analysis device which analyzes performance of a processor in a system LSI,
wherein the system LSI includes:
the processor which includes a plurality of logical processors, executes processing in parallel using the logical processors, and issues a first access request to access a memory;
a functional core which executes processing different from the processing executed by the processor and issues a second access request to access the memory; and
a memory interface which receives the first access request and the second access request and controls access to the memory,
said processor performance analysis device comprising:
a first information output unit configured to monitor the processor to output first information indicating an operating state of the processor;
a second information output unit configured to monitor the memory interface to output second information indicating a state of a memory access caused by the first and the second access requests received by the memory interface; and
an analysis unit configured to analyze the performance of the processor using the first information and the second information.

2. The processor performance analysis device according to claim 1, further comprising
a third information output unit configured to monitor the processor to output third information indicating a cause of the issuance of the first access request by the processor,
wherein said analysis unit is configured to further analyze the performance of the processor using the third information.

3. The processor performance analysis device according to claim 2,
wherein the processor issues the first access request to access the memory for each of the logical processors, and
said third information output unit is configured to output, as the third information, attribute information identifying a logical processor which is included in the logical processors and which issued the first access request.

4. The processor performance analysis device according to claim 2,
wherein the processor issues the first access request when a prefetch or a cache miss occurs, and
said third information output unit is configured to output, as the third information, information indicating which one of the prefetch or the cache miss is the cause of the issuance of the first access request by the processor.

5. The processor performance analysis device according to claim 4,
wherein the cache miss is one of an instruction cache miss, a data cache miss, and a translation lookaside buffer (TLB) miss.

6. The processor performance analysis device according to claim 1,
wherein said second information output unit is configured to output, as the second information, information indicating which one of the first access request and the second access request was received by the memory interface.

7. The processor performance analysis device according to claim 1,
wherein said second information output unit is configured to output, as the second information, either (i) information concerning waiting order of the first access request or the second access request, or (ii) information concerning time period from when the first access request or the second access request is received till a data transfer is completed.

8. The processor performance analysis device according to claim 1,
wherein said first information output unit is configured to output, as the first information, information indicating one of (i) whether each of the logical processors is operating or is in a waiting state, (ii) a cache hit or a cache miss of the processor, and (iii) a hit or a miss of a prefetch operation.

9. The processor performance analysis device according to claim 1,
wherein the system LSI includes a plurality of processors including the processor,
said processor performance analysis device comprising
first information output units each corresponding to said respective processors, said first information output units including the first information output unit.

10. The processor performance analysis device according to claim 1, further comprising
a trigger output unit configured to output a trigger signal when said trigger output unit receives an analysis result of the processor made by said analysis unit and the analysis result meets a predetermined condition.

11. The processor performance analysis device according to claim 1, further comprising
a bus access attribute information output unit configured to monitor the processor to output fourth information concerning the third access request issued for the functional core by the processor via a bus connecting the processor and the functional core,
wherein said analysis unit is configured to further analyze the performance of the processor using the fourth information.

12. A processor performance analysis method for analyzing performance of a processor in a system LSI,
wherein the system LSI includes:
the processor which includes a plurality of logical processors, executes processing in parallel using the logical processors, and issues a first access request to access a memory;
a functional core which executes processing different from the processing executed by the processor and issues a second access request to access the memory; and
a memory interface which receives the first access request and the second access request and controls access to the memory,
said processor performance analysis method comprising:
monitoring the processor to output first information indicating an operating state of the processor;
monitoring the memory interface to output second information indicating a state of a memory access caused by the first and the second access requests received by the memory interface; and
analyzing the performance of the processor using the first information and the second information.

13. A processor performance analysis simulator for analyzing performance of a processor in a system LSI,
wherein the system LSI includes:
the processor which includes a plurality of logical processors, executes processing in parallel using the logical processors, and issues a first access request to access a memory;
a functional core which executes processing different from the processing executed by the processor and issues a second access request to access the memory; and
a memory interface which receives the first access request and the second access request and controls access to the memory,
said processor performance analysis simulator comprising:
a first information output unit configured to monitor the processor to output first information indicating an operating state of the processor;
a second information output unit configured to monitor the memory interface to output second information indicating a state of a memory access caused by the first and the second access requests received by the memory interface; and
an analysis unit configured to analyze the performance of the processor using the first information and the second information.
